(19) United States
(12) Patent Application Publication
(10) Pub. No.: US 2009/0005715 A1
(43) Pub. Date: Jan. 1, 2009

(54) Massage machine

(75) Inventors: Shohei Taniguchi, Osaka (JP); Tetsushi Ogawa, Higashiosaka (JP)

Correspondence Address: BACON & THOMAS, PLLC, 625 SLATERS LANE, FOURTH FLOOR, ALEXANDRIA, VA, 22314-1176, US

(73) Assignee: Matsushita Electric Works, Ltd., Osaka (JP)

(21) Appl. No.: 12/213,312

(22) Filed: Jun. 18, 2008

(30) Foreign Application Priority Data
Jun. 26, 2007 (JP) 2007-168190

(51) Int. Cl. A61H 15/00

(52) U.S. Cl. 601/99

(57) ABSTRACT

A massage machine includes a massage member for massaging a back of a user's body and an operation unit for changing a massage force of the massage member applied to the user's body. A massage machine further includes a control unit for controlling the operation unit to adjust the massage force. The control unit adjusts the massage force of the massage member based on values set such that a massage force applied to a scapular region on the back of the user's body is smaller than a massage force applied to other regions of the user's body.

### FIELD OF THE INVENTION

The present invention relates to a massage machine and, more specifically, to a massage machine for massaging a back of a user's body.

### BACKGROUND OF THE INVENTION

There has been provided a massage machine having a massage member built in a backrest of a chair for massaging a back of a user's body. In this massage machine, the massage operation position is changed by moving up and down the massage member on the back of the user's body. Furthermore, massage intensity level is adjusted by altering an amount of which the massage member protrudes to the user's body. Japanese Patent Laid-open Publication No. S64-11549 describes a massage machine that allows a user to adjust the massage intensity levels on a region-by-region basis at a desired setting.

Since a human body is apt to feel painful in a scapular region, it is desirable that the scapular region may be massaged lightly. With the massage machine cited above, however, no light massage for the scapular region is available unless the massage intensity level in that region is set low by the user. For this reason, if the massage intensity level in the scapular region is set high by the user who confuses the scapular region with the remaining regions, the scapular region is heavily massaged to thereby inflict pain on the user.

### SUMMARY OF THE INVENTION

In view of the above, the present invention provides a massage machine capable of keeping a user free from pain during the course of massaging a scapular region.

In accordance with the present invention, there is provided a massage machine includes: a massage member for massaging a back of a user's body; an operation unit for changing a massage force of the massage member applied to the user's body; and a control unit for controlling the operation unit to adjust the massage force, wherein the control unit stores a preset value by which a massage force applied to a scapular region on the back of the user's body is kept smaller than a massage force applied to the remaining regions of the user's body, the control unit designed to adjust the massage force based on the preset value.

This ensures that the scapular region is massaged lightly at all times.

It is preferable that a ratio of the massage force applied to the scapular region to the massage force applied to the remaining regions is kept in a range of 1:1.1 to 1:1.5 and further preferable that the massage force applied to the scapular region is kept equal to 12±5 kg, while the massage force applied to the remaining regions is kept equal to 16±5 kg. The results may be obtained by the relationship between the pain and the massage effect.

The massage machine may further include a force detecting unit for detecting the massage force applied to the user's body, the control unit designed to control the operation unit based on a deviation between a force detected by the force detecting unit and a preset target massage force or, the massage machine may further include a position detecting unit for detecting a protruding position of the massage member, the control unit designed to control the operation unit based on a deviation between a massage force estimated from the protruding position detected by the position detecting unit and a preset target massage force.

This makes it possible to massage a user with a suitable massage force regardless of the physique of the user and the sitting manner. In addition, since a high-cost sensor for detecting the force is not needed in case of using the position detecting unit, the massage machine can be provided in a cost-effective manner.

Preferably, the operation unit includes a flexibility control unit for virtually setting inertia, viscosity and elasticity of the massage member. This makes it possible to set the massage intensity level of the massage member from a soft level to a hard level on a region-by-region basis.

The massage machine may further include an actuator displaceable according to a torque command value as a massage drive source, the control unit designed to change the massage force by increasing or decreasing the torque command value. This is advantageous from the standpoint of cost.

The control unit may be designed to estimate an optimal massage force based on the information on a user and to adjust the massage force to become equal to the optimal massage force thus estimated. This makes it possible to perform massage in a user-specific manner.

With the present invention, the scapular region can be massaged lightly at all times. This eliminates the possibility that the scapular region is massaged too heavily, thereby keeping the user free from pain.

### BRIEF DESCRIPTION OF THE DRAWINGS

The object and features of the present invention will become apparent from the following description of embodiments given in conjunction with the accompanying drawings, in which:

FIG. 1 is a schematic view showing a massage machine in accordance with an embodiment of the present invention;

FIG. 2 is a graph representing the relationship between a massage force of a massage member and the score of comfort and also the relationship between the massage force and the score of pain;

FIG. 3 is a graph representing the relationship between the protruding position of the massage member and the massage force;

FIG. 4 is a view for explaining how to control the flexibility of the massage member; and

FIG. 5 is a view for explaining the information on a user.

### DETAILED DESCRIPTION OF THE EMBODIMENTS

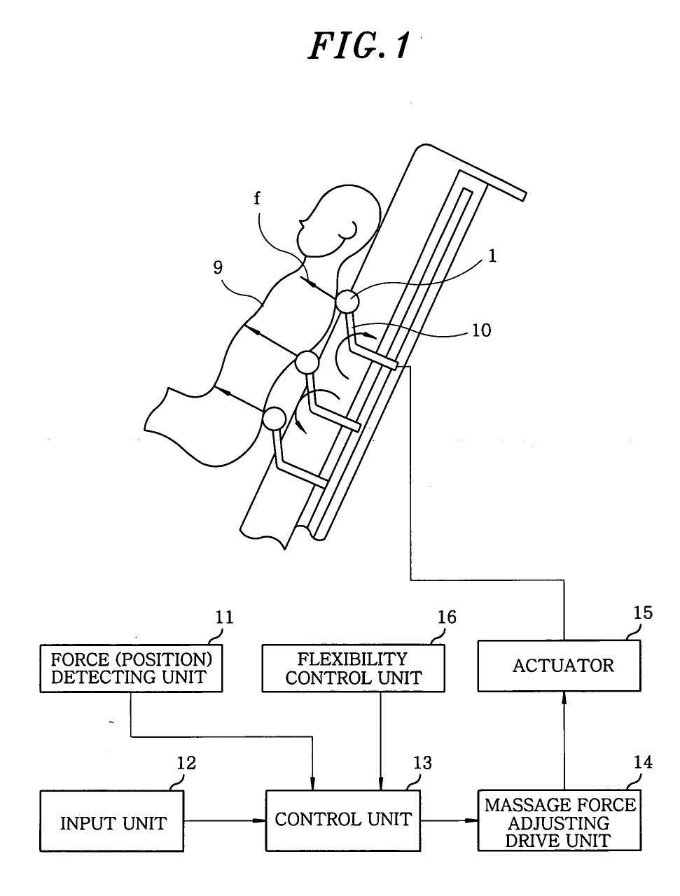

Hereinafter, the present invention will be described with respect to an embodiment illustrated in FIGS. 1 to 5, which form a part hereof.

FIG. 1 is a schematic view showing a massage machine in accordance with the embodiment of the present invention. As shown in FIG. 1, the massage machine includes a massage member 1, arranged within a backrest of a chair, movable in an up-and-down direction and is designed to massage a back of a user's body 9 by operating the massage member 1 brought into contact with the back of the user's body 9. A massage force f of the massage member 1 applied to the user's body 9 is adjustable by, e.g., rotating a link 10 connected to the massage member 1 and altering the body-side protrusion amount of the massage member 1. The configuration of a mechanism for driving the massage member 1 carrying out a massage operation and the configuration of a mechanism for adjusting the massage force f may be of any type known in the art, the details of which will be omitted herein.

The task of controlling the operation of the massage member 1 is governed by a control unit 13. The control unit 13 determines a current massaging region of the user's body 9 from a vertical position of the massage member 1. For example, the massage machine is provided with an input unit 12, so that a user can input information of his/her height by using the input unit 12. The control unit 13 determines, based on the information, a region of the user's body corresponding to a vertical position of the massage member 1, e.g., regions of a neck, a scapular, a shoulder, a waist or the like and controls a massage force adjusting drive unit 14 so that the massage force f applied to the current massaging region can be kept equal to or smaller than a preset value.

In particular, since the upper limit value of the massage force f applied to the scapular region is set smaller than that applied to the remaining regions, when the scapular region of the user's body 9 is massaged by the massage member 1, the scapular region is massaged only with a massage force smaller than that applied to the remaining regions. In other words, if the massage member 1 is moved from the remaining regions to the scapular region, the massage force f is automatically reduced below the massage forces applied to the remaining regions.

In order to massage different users with an optimal average massage force, it is desirable that the ratio of the massage force f applied to the scapular region to the massage force applied to the remaining regions be 1:1.1 to 1:1.5.

According to the evaluation conducted by monitoring users, it is preferred that the massage force f applied to the scapular region be set equal to 12±5 kg, while the massage force f applied to the remaining regions is set equal to 16±5 kg.

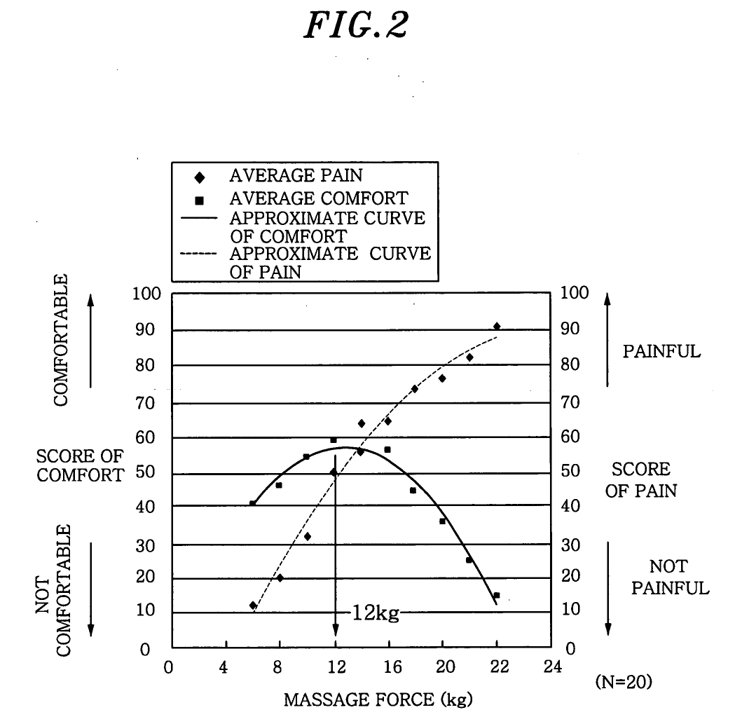

Shown in FIG. 2 is one example of the monitoring evaluation. The graph shown in FIG. 2 is a result of subjective evaluation on the massage of the scapular region. In the graph, the horizontal axis indicates the massage force, the left vertical axis indicates the score of comfort, and the right vertical axis indicates the score of pain. The score of pain is increased proportional to the massage force, whereas the score of comfort shows a peak at the optimal massage force and drops as the massage force becomes too small or too great. In a nutshell, the present massage machine is designed to set the optimal massage force applied to each of the body regions on the basis of the above-noted evaluation.

In order to adjust the massage force f, a force detecting unit 11 capable of detecting the massage force f of the massage member 1 applied to the user's body is provided, e.g., to the massage member 1. For example, a pressure sensor (not shown) may be arranged as the force detecting unit 11 for detecting a force applied to the user's body by measuring a contact pressure of the massage member 1. Based on the deviation between a massage force detected by the force detecting unit 11 and a preset target massage force, the massage force adjusting drive unit 14 is feedback-controlled so that the massage can be performed with the target massage force at all times.

In view of the costliness of the force detecting unit 11, it may be replaced with a position detecting unit for detecting the protruding position (protruding amount) of the massage member 1 to the user's body. For example, an optical sensing mechanism disclosed in Japanese Patent Laid-open Publication No. S64-11549 may be provided as the position detecting unit for detecting the protruding position of the massage member 1 by measuring a rotation angle of the link 10. In this case, a massage force is estimated from the position detected by the position detecting unit. Then, the massage force adjusting drive unit 14 is controlled based on the deviation between the estimated massage force and the preset target massage force. This makes it possible to feedback-control the massage force adjusting drive unit 14 in a cost-effective manner.

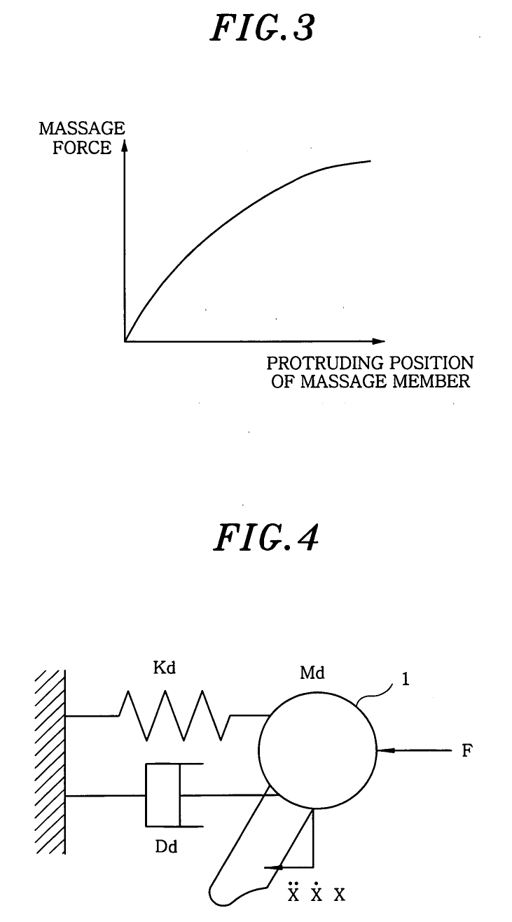

In case of estimating the massage force from the detected protruding position of the massage member 1, data on a relationship between each of the protruding positions and massage forces are collected in advance as shown in FIG. 3 and then the massage force is estimated from the detected protruding position based on the collected data. Such estimation is preferred because of convenience and ease.

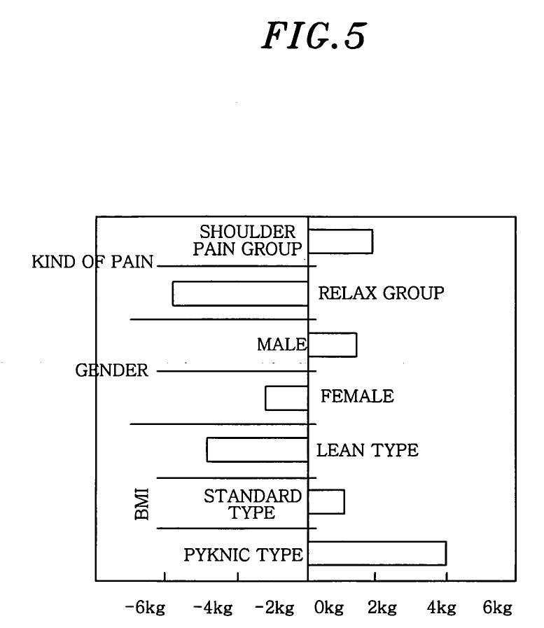

In addition, as shown in FIG. 4, it may be possible to apply a flexibility control unit 16 by which the flexibility of the massage member 1 is virtually set and controlled. In this case, the properties of the massage member 1 for realizing the flexibility, including inertia, viscosity and elasticity, are virtually set and a massage force is adjusted by realizing the flexibility of the massage member 1 on a software based on the flexibility control. For example, if a user wishes to reduce the massage force f, the parameters of inertia, viscosity and elasticity are set to make the massage member 1 soft. If the user wishes to increase the massage force f, the parameters are adjusted to make the massage member 1 hard.

Examples of the flexibility control that virtually realizes the properties such as inertia, viscosity and elasticity in the massage member 1 includes a method of measuring a force and controlling a motion and a method of measuring a displacement and controlling a force, in such a manner as to realize the flexibility represented by the equation:

F=Md(\ddot{x}d−\ddot{x})+Dd(\dot{x}d−\dot{x})+Kd(xd−x),

where F is a force vector, Md is a desired inertia characteristic matrix, Dd is a desired viscosity characteristic matrix, Kd is a desired elasticity characteristic matrix, x is a translating and rotating displacement vector of the massage member and xd is a target translating and rotating displacement vector of the massage member (in the natural length of an elastic element).

It may be possible to employ any method if the flexibility can be realized on a software basis. In the above equation, the parameters Md, Dd and Kd can be arbitrarily selected among the values including zero. If Md becomes greater, it is difficult to accelerate the massage member 1. If Dd is increased, it becomes difficult for the massage member 1 to have a desired speed. As Kd is set greater, it is difficult to displace the massage member 1. Although the above equation is directed to a simple linear model, other models including a non-linear model may apply in place thereof.

In case an actuator 15 displaceable according to a torque command value is used as a massage member drive source for causing the massage member 1 to perform a massage operation, the massage force f may be changed by increasing or decreasing the torque command value. In this case, the massage force f can be properly adjusted without having to use the force detecting unit 11 or the like.

FIG. 5 shows one example of analysis results obtained by analyzing the optimal massage force from the information on “kind of pain (shoulder pain group or no shoulder pain group (relax group))”, “gender” and “BMI (weight(kg)/height(m)²)”. Based on these analysis results, the optimal massage force f for the user may be estimated using the equation:

optimal massage force=kind of pain+gender+BMI+16(kg),

where the numeral 16 is an integer term introduced as an example. Then, the massage may be performed with this massage force f.

Since the optimal massage force is estimated according to the information on the user, it is possible to perform the massage with a suitable massage force f. For example, information of a user's body, e.g., a height, a gender, a weight, kind of pain and the like, are inputted by using the input unit 12, and the control unit 13 controls the massage force adjusting drive unit 14 to perform a massage operation based on the input information.

Although three information items, i.e., the kind of pain, the gender and the BMI, are used as the information herein, one or two of these information items or other information items may be used to estimate the optimal massage force.

While the invention has been shown and described with respect to the embodiments, it will be understood by those skilled in the art that various changes and modifications may be made without departing from the scope of the invention as defined in the following claims.

What is claimed is:

1. A massage machine comprising:
a massage member for massaging a back of a user's body;
an operation unit for changing a massage force of the massage member applied to the user's body; and
a control unit for controlling the operation unit to adjust the massage force, wherein the control unit adjusts the massage force of the massage member based on values set such that a massage force applied to a scapular region on the back of the user's body is smaller than a massage force applied to other regions of the user's body.

2. The massage machine of claim 1, wherein the control unit is designed to ensure that the ratio of the massage force applied to the scapular region to the massage force applied to the other regions is kept in a range of 1:1.1 to 1:1.5.

3. The massage machine of claim 1, wherein the control unit is designed to ensure that the massage force applied to the scapular region is kept equal to 12±5 kg, while the massage force applied to the other regions is kept equal to 16±5 kg.

4. The massage machine of claim 1, further comprising a force detecting unit for detecting the massage force applied to the user's body, wherein the control unit controls the operation unit based on a deviation between a force detected by the force detecting unit and a preset target massage force.

5. The massage machine of claim 1, further comprising a position detecting unit for detecting a protruding position of the massage member, wherein the control unit controls the operation unit based on a deviation between a massage force estimated from the protruding position detected by the position detecting unit and a preset target massage force.

6. The massage machine of claim 1, wherein the operation unit comprises a flexibility control unit for virtually setting inertia, viscosity and elasticity of the massage member.

7. The massage machine of claim 1, further comprising an actuator displaceable according to a torque command value as a massage drive source, wherein the control unit changes the massage force by increasing or decreasing the torque command value.

8. The massage machine of claim 1, wherein the control unit estimates an optimal massage force based on the information on a user and adjusts the massage force to become equal to the optimal massage force thus estimated.

9. A massage machine comprising:
a massage member for massaging a back of a user's body;
an operation unit for changing a massage force of the massage member applied to the user's body; and
a control unit for controlling the operation unit to adjust the massage force,
wherein the control unit determines a current massaging region of the user's body from a vertical position of the massage member, and if it is determined that the massage region corresponding to the vertical position of the massage member is a scapular region, the control unit controls the operation unit to change the massage force of the massage member to a preset target massage force.
